(19) United States
(12) Patent Application Publication
(10) Pub. No.: US 2010/0176769 A1
(43) Pub. Date: Jul. 15, 2010

(54) CONTROL SYSTEM AND A METHOD OF CONTROLLING OF A TCSC IN AN ELECTRICAL TRANSMISSION NETWORK, USING IN PARTICULAR AN APPROACH OF THE LYAPUNOV TYPE

(75) Inventors: Abdelkrim Benchaib, Montigny Le Bretonneux (FR); Serge Poullain, Arpajon (FR); Yannick Weiler, Paris (FR)

Correspondence Address: Nixon Peabody LLP, P.O. Box 60610, Palo Alto, CA, 94306, US

(73) Assignee: Areva T&D SAS, Paris La Defense Cedex (FR)

(21) Appl. No.: 12/597,481

(22) PCT Filed: Apr. 22, 2008
(86) PCT No.: PCT/EP2008/054843

§ 371 Date: Feb. 10, 2010

(30) Foreign Application Priority Data
Apr. 24, 2007 (FR) 07 54660

(51) Int. Cl. G05F 1/70

(52) U.S. Cl. 323/205

(57) ABSTRACT

A system and method of controlling a TCSC disposed on a high voltage line of an electrical transmission network. The system comprises: (a) a voltage measuring module; (b) a current measuring module; (c) a regulator, working in accordance with a non-linear control law to receive on its input the output signals from the two modules for measuring voltage and current, and a reference voltage corresponding to the fundamental of the voltage which is to obtained across the TCSC; (d) a module for extracting the control angle in accordance with an extraction algorithm; and (e) a module for controlling the thyristors (T1, T2) of the TCSC, and for receiving a zero current reference delivered by a phase-locked loop which gives the position of the current.

### CROSS REFERENCE TO RELATED APPLICATIONS OR PRIORITY CLAIM

This application is a national phase of International Application No. PCT/EP2008/054843, entitled “SYSTEM AND METHOD FOR CONTROL OF A TCSC IN AN ELECTRICITY TRANSPORT NETWORK, SPECIFICALLY USING A LYAPUNOV APPROACH”, which was filed on Apr. 22, 2008, and which claims priority of French Patent Application No. 07 54660, filed Apr. 24, 2007.

### DESCRIPTION

1. Technical Field

This invention relates to a control system and to a method of controlling a TCSC in an electrical transmission network, using in particular an approach of the Lyapunov type.

2. Current State of the Prior Art

The prevailing steady growth in the demand for electricity is saturating the great power transmission and distribution grids. The opening up of the market for electric power in Europe, which is of major importance economically, does however raise a large number of problems, and in particular it points to the importance of connecting national grids to one another, with those grids on which there is less demand being thereby able to support the ones which are more heavily loaded. The major blackouts (due to breakdown of the distribution network or loss of synchronism) which occurred in the United States and in Europe (Italy) in the course of the year 2003, as a result of very high power demand, made the appropriate authorities aware of the need to develop the networks in parallel with the development in the demand for power. But then, maximization of power transfer becomes a new constraint that has to be taken into account. Management and control of the production units, regulation, and capacities that can be varied using mechanical interrupters have been the principal methods employed for control of the flow of power. However, there do exist applications requiring continuous control, which would be impossible with such methods. Flexible alternating current transmission systems (FACTS) can respond adequately to these new requirements, by controlling reactive power. Among these systems, and in spite of recent technological advances, the thyristor controlled series capacitor or TCSC remains the solution that offers the best compromise between economic and technical criteria. Besides controlling reactive power, it enables the stability of the network to be increased, in particular in the presence of hypo-synchronous resonance phenomena.

### THE PRINCIPLE OF POWER TRANSFER

In an energy transport network, electricity is generated by the alternators as three-phase alternating current (AC), and the voltage is then increased by step-up transformers to very high voltages before being transmitted over the network. The very high voltage enables power to be transported over long distances, while lightening the structures of the network and reducing heating losses. Voltage does however remain limited by the constraints of the need to isolate the various items of equipment, and also by electromagnetic radiation effects. The range of voltage which offers a good compromise is from 400 kilovolts (kV) to 800 kV.

In order for power to be able to pass between a source and a receiver it is necessary for the voltage of the source to be out of phase relative to the receiver voltage, by an angle θ. This angle θ is called the internal angle of the line or the transmission angle.

If Vs is the voltage on the source side, Vr the voltage on the receiver side, and X1 the purely inductive impedance of the line, then the active power P and reactive power Q provided by the source are expressed by the following expressions respectively:

$$P = \frac{{V}_{s} {V}_{r}}{X 1} sin θ$$

$$Q = \frac{{V}_{s}^{2} - {V}_{s} {V}_{r} cos θ}{X 1}$$

$${P}_{max} = \frac{{V}_{s} {V}_{r}}{X 1}$$

These expressions show that the active power and reactive power transmitted over an inductive line are a function of the voltages Vs and Vr, the impedance X1, and the transmission angle θ.

There are then three possible ways in which the power that can be transmitted over the line may be increased, as follows.

Increase the voltages Vs and Vr. We are then at once limited by the distances needed for isolation purposes and by the dimensioning of the installation. The radiated electromagnetic field is greater. There is therefore an environmental impact to be taken into account. Moreover, the equipment is more expensive and maintenance is costly.

Act on the transmission angle θ. This angle is a function of the active power supplied by the production sites. The maximum angle corresponding to Pₘₐₓ is θ=π/2. For larger angles, we enter into the descending part of the curve P=f(θ), which is an unstable zone. To work with angles θ that are too large is to run the risk of losing control of the network, especially with a transient fault (for example one causing grounding of the phases) on the network where the return to normal operation involves a transient increase in the transmission angle (in order to evacuate the energy which was produced during the fault condition, which could not be used by the load, and which has been stored in the form of kinetic energy in the rotors of the generators). It is therefore important that the angle should not exceed the limit of stability.

Act on the value of the impedance X1, which can be lowered by putting a capacitor in series with the line, thereby compensating for the reactive power which is generated by the power transport line. As the value of the impedance X1 falls, the power that can be transmitted increases for a given transmission angle. Series FACTS equipment consists of appliances that enable this reactive energy compensation function to be achieved. The best known series FACTS device is the fixed capacitor or FC. However, it does not allow the degree of compensation to be adjusted. If such adjustment is required, it is then possible to make use of a TCSC system.

### Use of Series FACTS Equipment for Reactive Power Compensation

The use of FACTS opens up new perspectives for more effective exploitation of power networks with continuous and rapid action on the various parameters of the network, namely phase shifting, voltage, and impedance. Power transfers are thus controlled, and voltage levels maintained, to the best advantage, which enables the margins of stability and level maintenance to be increased with a view to making use of the power lines by transferring the maximum current, at the limit of the thermal strength of these lines, at high and very high voltages.

FACTS can be classified in two families, namely parallel FACTS and series FACTS, as follows:

Parallel FACTS comprise, in particular, the mechanical switched capacitor or MSC, the static Var compensator (SVC), and the static synchronous compensator or STATCOM; and

Series FACTS consist, in particular of the fixed capacitor or FC, the thyristor switch series capacitor or TSSC, the thyristor control series capacitor or TCSC, and the static synchronous series compensator or SSSC.

The most elementary form of series FACTS device consists of a simple capacitor (FC) connected in series on the transmission line. This capacitor partly compensates for the inductance of the line. If Xc is the impedance of this capacitor, and neglecting the resistance of the cables, the power transmitted by the compensated line can be written as:

$$P = \frac{{V}_{s} {V}_{r}}{X l - Xc} sin θ$$

If

$$kc = \frac{Xc}{Xl} ,$$

the amount of compensation of the line, the above expression becomes:

$$P = \frac{{V}_{s} {V}_{r}}{Xl ( 1 - kc )} sin θ$$

FIG. 1 shows the variation in active power as a function of the transmission angle, for three different values of the amount of compensation, namely 0% (curve 10), 30% (curve 11), and 60% (curve 12). The improvement made by the series compensation can be clearly seen. In this regard, the amount of compensation acts directly on the value Pₘₐₓ. Thus, the greater the amount of compensation applied, the greater is the amount of power that can be transmitted, or the smaller the transmission angle for a given amount of power to be carried. In addition, the increase in the amount of power that can be transmitted enables the overall stability of the network to be improved in the event of a transient fault in the power transmission line, by producing an increase in the margin of stability (i.e. the margin of active power which is available before reaching the angle that is critical to stability).

However, the association of capacitors having a fixed and constant capacitance with the inductance of the transport line constitutes a resonant system with little damping. In some particular circumstances, especially on returning to normal operation following a fault on the transmission line, this resonant system can go into oscillation through an exchange of energy with the resonant mechanical system consisting of the masses and the shafts of the turbines of the turbo alternators. This energy exchange phenomenon (which is also known as sub-synchronous resonance or SSR) gives rise to oscillations of power (and therefore of electromagnetic torque) of high amplitude, which can sometimes give rise to fracture of the mechanical shafts in the rotating parts of the generators.

In order to damp out these power oscillations, it is accordingly possible to make use of a controllable series capacitor (CSC) for artificially damping the oscillations by active control of the inserted capacitive reactance (and therefore of impedance). Equipment suitable for damping out power oscillations makes use of thyristors to control this reactance. The most commonly used apparatus is the thyristor controlled series capacitor or TCSC, which offers a good solution to the problems of stability in networks, and which is one of the least expensive FACTS devices.

### Use of TCSC Devices for Reactive Power Compensation

As is shown in FIG. 2, a TCSC consists of two parallel branches. The first branch consists of two thyristors T1 and T2 which are connected back to back in series with an inductance L. This branch is called a TCR or thyristor controlled reactor, which can be compared to a variable inductance. The second branch contains only a capacitor C. The variable inductance, which is connected in parallel with the capacitor, enables the impedance of the TCSC to be varied by compensating wholly or partly for the reactive energy produced by the capacitor. The modification of the value of this impedance is obtained by adjusting the trigger angle of the thyristors, i.e. the instant within a period when the thyristors begin to conduct. There is a critical zone corresponding to the resonance of the circuit LC. FIG. 3 enables the overall impedance of the TCSC to be seen as a function of the trigger angle. The zone of resonance 15 can be clearly seen.

The TCSC has two main operating modes, namely the capacitive mode and the inductive mode. The operating mode depends on the value of the trigger angle. Starting of the TCSC can only take place in the capacitive mode.

For a trigger angle greater than the resonance value, the TCSC is in capacitive mode, and the current is in advance of voltage. The TCSC then works as a capacitor and compensates partly for the inductance in the line. FIG. 4 accordingly illustrates operation in capacitive mode, in which the curve 20 represents capacitive mode, the curve 21 represents line current, and curve 22 represents the capacitive voltage (angle α=65°).

The voltage across the capacitor is increased (or boosted) by virtue of a surplus of current arising from the load of the inductance, which is added to the line current when one of the thyristors, for example the thyristor T1, is closed. This increase may be characterized by the ratio Kb=X_{TCSC}/X_{CT}, which is called the boost factor, where X_{CT} is the impedance of the capacitor by itself. During the next half period, the triggering of the other thyristor, for example the thyristor T2, enables the cycle to be reproduced for the opposite phase. The triggering of the thyristors T1 and T2 thus causes a charge/discharge cycle to occur from the inductance towards the capacitor C in each half period. The complete cycle lasts for one full period of the line current. The two thyristors T1 and T2 are controlled in parallel, with one of them being open while the other is closed, and this sequence varies with the alternation of the current.

In an inductive operating mode, the trigger angle is below the resonance value, and the current is retarded relative to the voltage. The order of thyristor triggering is reversed. The voltage is severely deformed by the presence of harmonics which are not insignificant. Accordingly, FIG. 5 shows operation in inductive mode, in which the curve 25 represents capacitive current, curve 26 represents line current, and curve 27 represents capacitive voltage.

TCSCs are mainly used in capacitive mode, but in some particular circumstances they have to work in inductive mode. The change from one mode to the other takes place in response to the thyristors being controlled in a particular way. The transitions are only possible if the time constant of the LC circuit is lower than the period of the network.

In normal operation, the point at which the voltage across the TCSC passes through zero (and therefore the minimum value or maximum value of the current in the TCSC depending on the alternation of the line current) corresponds exactly to the maximum value of the line current, i.e. π/2 for a sinusoidal current. Numerous modeling calculations can be made easier by considering steady conditions. In this regard, the symmetry that results from such an approximation enables the various expressions involved in the modeling exercise to be simplified to a great extent. However, the resulting model is then valid only for steady conditions, which is a great limitation because control is effected by varying the trigger angle.

Once operation becomes transient, that is to say as soon as the trigger angle changes, the symmetry referred to above disappears, and as shown in FIG. 6, a phase shift angle Ø is found between the occurrence of the maximum value of the line current I₁ (see curve 30) and the instant when the voltage v across the TCSC passes through zero (see curve 31), and curve 32 represents the current i in the inductance of the TCSC. The phase shift angle Ø is due to the permanent energy exchanges between the inductance and the capacitance. So long as this angle Ø, which may be seen as a disturbance, remains relatively small, the system is able to damp it out and remain stable. However, higher values of the angle Ø can lead to increasing energy exchanges, thus leading to instability of the system.

The trigger angle α and the end-of-conduction angle τ can be expressed as a function of the phase shift angle Ø, in the following relationships:

α=π/2−σ/2+Ø

τ=π/2+σ/2+Ø

### Modeling the TCSC

In what follows, the following assumptions are made:

the thyristors are considered as being ideal, and any non-linearity on opening or closing is ignored;

the thyristors are connected in a simple line connecting a generator delivering to an infinite bus;

the line current is expressed as i₁=I₁ sin(ωₛt) and the instant of maximum current is π/2; and

we are in the sector [α, α+π].

The following notation is introduced:

α: trigger angle of the thyristors;

τ: end-of-conduction angle;

σ=τ=α: duration of conduction;

Ø: phase shift angle;

ω₀: resonant (angular) frequency;

ωₛ: network frequency;

$$S = \frac{{ω}_{0}^{2}}{{ω}_{0}^{2} - {ω}_{s}^{2}} ;$$

$$η = \frac{{ω}_{0}}{{ω}_{s}} , ;$$

L: inductance, R: resistance, C: capacitance of the TCSC;

network frequency: ωₛ=2*50*π;

resonant frequency:

$${ω}_{0} = \frac{1}{\sqrt{LC}} ;$$

root mean square (rms) capacitance:

$${C}_{eff} ( β ) = {\{ \frac{1}{C} - \frac{4}{π} [ \begin{matrix}\frac{1}{2 C} S ( β + \frac{sin ( 2 β )}{2} ) + \\ {ω}_{s}^{2} {LS}^{2} {cos}^{2} ( β ) ( tan ( β ) - η tan ( η β ) )\end{matrix} ] \}}^{- 1}$$

β: semi-conduction angle

u*=ωₛC_{eff}(β*): equivalent admittance value of the TCSC;

$${V}^{*} = {[ {V}_{1}^{*} , {V}_{2}^{*} ]}^{T} = {[ - \frac{\vert {i}_{l} \vert}{{u}^{*}} , 0 ]}^{T} \text{:} reference voltage ;$$

V₁ and V₂: measured voltages;

V₁* and V₂*: reference voltages,

\tilde{V}₁ and \tilde{V}₂: voltage tracking error

The main objective is to propose a model of the state of the TCSC that is adapted to represent its dynamic behavior over the whole working range. From Kirchhoffs laws and the description of the operation of the TCSC, the equations governing the dynamics of the system are summarized by the following equation system:

$$\{ \begin{matrix}C \frac{d v}{d t} = {i}_{l} - i \\ L \frac{d i}{d t} = qv - Ri\end{matrix}$$

where q is the switching function, such that q=1 for ωₛt ε[α, τ], and q=0 for ωₛt ε[τ, π+α].

Since the parameter q can assume two different and discrete values depending on the state of the system, the model obtained is similar to a state model of the “variable structure” or “hybrid” type (i.e. an association of continuous magnitudes and discrete magnitudes). A model of this kind lends itself rather badly to the use of conventional techniques for synthesizing non-linear control laws, except where they address very particular techniques in the control of hybrid systems.

In order to obtain a model that is better adapted, the notion of a phaser is now introduced. The Fourier decomposition into phasers, averaged over a period T, eliminates the need to consider this double structure of the state model.

The generalized average method that is performed here to obtain the model for phaser dynamics is based on the fact that a sinusoid x(.) may be represented over the time interval]t−T, t] with the aid of a Fourier series of the form:

$$x ( τ ) = Re \{ {\sum }_{k \geq 0} {X}_{k} ( t ) {e}^{j k {ω}_{s} τ} \} \\ {ω}_{s} = \frac{2 π}{T} \\ τ ∈ ] t - T , t ]$$

where Re represents the real part, and Xₖ(t) are the complex Fourier coefficients that are also be referred to as phasers. These Fourier coefficients are functions of time, because the time interval considered depends on time (one could speak of a moving window). The k^{th} coefficient (or phaser k) at time t is given by the following average:

$${X}_{k} ( t ) = \frac{c}{T } {\int }_{t - T}^{t} X ( τ ) {e}^{- j k {ω}_{s} t} d τ$$

$${X}_{k} ( t ) = < x {>}_{k} ( t )$$

where c=1 for k=0 and c=2 for k=>0. A state model is obtained for which the coefficients defined above are state variables.

The sinusoidal function obtained with the Fourier coefficient of index k is called the harmonic function of range k of the function x. This is the function

Xₖe^{jkw}^{ₛ}^{τ}. The first harmonic is referred to as the fundamental.

For k=0, the coefficient X₀ is merely the mean value of x.

The derivative of the k^{th} Fourier coefficient is given by the following expression:

$$\frac{d {X}_{k}}{d t} = < \frac{d x}{d t} {>}_{k} - j k {ω}_{s} {X}_{k}$$

It may also be observed that if f(t+T/2)=−f(t), the even harmonics off are zero.

The convention for writing complexes can vary. Most papers relating to the modeling and control of a TCSC have adapted the convention z=a−ib, and not z=a+ib, which is the writing convention used here. However, it should be observed that this choice has no influence whatsoever on the results presented, so long as the decomposition of the complex equations, partly real and partly imaginary, is performed rigorously and stays with the convention adopted from the start. The Fourier transformation in itself remains identical in both cases. The only major difference arises from the sign of ωₛ. In this regard, by adopting the a−ib convention, the orientation of the axis of the imaginary parts is changed, so that rotation of the phasers changes in direction, and ωₛ becomes negative.

Since the static model cannot be made use of and is found to be insufficient, we now try to establish a model that is dynamic concerning voltage and current fundamentals.

Making use of the Fourier decomposition, it is thus possible to establish the dynamics of the phasers of the voltage and current signals.

Starting from the equations that govern the dynamics of voltage and current, given above:

$$\{ \begin{matrix}C \frac{d v}{d t} = {i}_{lk} - i \\ L \frac{d i}{d t} = qv - Ri\end{matrix}$$

the Fourier transform is applied, and the following model is then obtained:

$$\{ \begin{matrix}C < \frac{d v}{d t} {>}_{k} = < {i}_{l} {>}_{k} - < i {>}_{k} \\ L < \frac{d i}{d t} {>}_{k} = < qv {>}_{k} - R < i {>}_{k}\end{matrix}$$

with

$$< qv {>}_{k} = \frac{2 {ω}_{s}}{π} {\int }_{α / {ω}_{s}}^{τ / {ω}_{s}} v ( {ω}_{s} t ) {e}^{- j k {ω}_{s} t} d t .$$

From the above expression giving dXt/dt, the above equations become:

$$\{ \begin{matrix}C \frac{d {V}_{k}}{d t} = {I}_{lk} - {I}_{k} - \frac{1}{C} j k {ω}_{s} {V}_{k} \\ L \frac{d {I}_{k}}{d t} = < qv {>}_{k} - {RI}_{k} - \frac{1}{L} j k {ω}_{s} {I}_{k}\end{matrix}$$

To start with, only the fundamental is considered.

The real parts (cosine) and the imaginary parts (sine) of the fundamentals (or first phasers) of the voltage and current are designated as V1c, V1s, I1c, I1s. We then have:

V₁=V_{1c}+jV₁ₛ

I₁=I_{1c}+jI₁ₛ

It is known that the contribution of the fundamental to the total signal is of the form:

v₁=V_{1c} cos(ωₛt)−V₁ₛ sin(ωₛt)

Thus calculating <qv>₁ gives:

$$< qv {>}_{1} = \frac{1}{π} [ {V}_{1} σ + {\tilde{V}}_{1} sin ( σ ) {e}^{- 2 j ( \frac{π}{2} + φ )} ]$$

In this way a complex state model of the second order is obtained. By separating the real and imaginary parts, a real model of order 4 is obtained, having the following state variables:

$$\{ \begin{matrix}C \frac{d {V}_{1 c}}{d t} = {I}_{11 c} - {I}_{1 c} - \frac{1}{C} j {ω}_{s} {V}_{1 s} \\ C \frac{d {V}_{1 s}}{d t} = {I}_{11 s} - {I}_{1 s} - \frac{1}{C} j {ω}_{s} {V}_{1 c} \\ L \frac{d {I}_{1 c}}{d t} = Re ( < qv {>}_{1} ) - {RI}_{1 c} - \frac{1}{L} j {ω}_{s} {I}_{1 s} \\ L \frac{d {I}_{1 s}}{d t} = Im ( < qv {>}_{1} ) - {RI}_{1 s} - \frac{1}{L} j {ω}_{s} {I}_{1 c}\end{matrix}$$

However, if α is controlled, τ depends on the current in the inductance passing through zero, and can be determined by solving a transcendental equation. Consequently, τ does not only depend on V₁, I₁ and I₁. However, some approximations enable the above system to be converted into a true state model. For this purpose it is enough to be able to express Ø as a function of the quantities given above. It is assumed that the signal is sufficiently close in value to the signal obtained with the fundamental alone. Ø can then be expressed as the offset between the fundamental of the line current and the fundamental of the current in the inductance, i.e.:

Ø=arg[−I_{l*}Ī₁]

All the parameters in the model may thus be determined as a function of V₁, I₁, and I₁.

### Control Laws for the TCSC

The document referenced [1] at the end of this description defines a device for controlling a TCSC in accordance with a control law that is such that the instants when the voltage across the terminals of the capacitor of the TCSC passes through zero are substantially equidistant from one another, even during the periods in which the current passing into the power line contains sub-synchronous components as well as its fundamental component.

A second document in the prior art, that is to say the document referenced [2], describes three non-linear control laws for a TCSC system, namely a control law that is synthesized by an approach of the Lyapunov type, a control law of the interconnection and damping assignment (IDA) type, and a control law that is obtained by a technique of the feedback linearization control (FLC) type. That document analyses the stability of these three control laws, and makes use of simulations in the time domain in order to verify the performance obtained by the use of these three control laws. The document also describes a so-called Lyapunov type control law. However, the performance obtained with this control law turns out to be insufficient, especially relative to the following two technical problems:

the existence of static errors, the magnitude of which is greater the closer the operating point is to the resonance zone of the TCSC; and

a lack of robustness in the presence of outside perturbations (where robustness is required for performance to be maintained).

An object of the invention is to provide a system and a method for controlling a TCSC, in an electrical transmission network, by proposing novel control laws for generating the instants at which the thyristors of the TCSC are triggered.

### SUMMARY OF THE INVENTION

The invention provides a control system for a TCSC disposed on a high voltage line of an electrical transmission network, which comprises:

a voltage measuring module that enables the harmonics of the voltage across the TCSC to be extracted;

a current measuring module that enables the amplitude of the fundamental, and possibly of other harmonics, of the current flowing in the high voltage line to be extracted;

a regulator working in accordance with a non-linear control law, that receives as input the output signals from the two modules measuring voltage and current, and a reference voltage corresponding to the fundamental of the voltage that is to be obtained across the TCSC, the regulator delivering an equivalent effective admittance;

a module for extracting the control angle in accordance with an extraction algorithm that receives the said equivalent effective admittance and that delivers a control angle; characterized in that it further comprises:

a module for controlling the thyristors of the TCSC, which module receives the said control angle and a zero current reference that is delivered by a phase-locked loop giving the position of the current,

and in that the control law is such that

$$u = \{ \begin{matrix}{u}_{max} , & {u}_{tot} & \geq {u}_{max} & \\ {u}_{tot} , & {u}_{min} & \leq {u}_{tot} & \leq {u}_{max} \\ {u}_{min} , & {u}_{tot} & \leq {u}_{min} & \end{matrix}$$

where:

$${u}_{tot} = {u}^{*} - sign ( {u}^{*} ) {R}_{2} {\tilde{V}}_{2} + {u}^{*} {\tilde{V}}_{1} \frac{C}{{\tilde{V}}_{2} \vert {i}_{l} \vert} {\dot{V}}_{1}^{*} - {R}_{3} \frac{{\tilde{V}}_{1}}{\vert {\tilde{V}}_{1} \vert + ɛ}$$

and:

u*=ωₛC_{eff}(β*), the equivalent effective admittance at the equilibrium point (under steady conditions);

$${V}^{*} = {[ {V}_{1}^{*} , {V}_{2}^{*} ]}^{T} = {[ - \frac{\vert {i}_{l} \vert}{{u}^{*}} , 0 ]}^{T} \text{:}$$

reference voltage;

V₁ and V₂: measured voltages;

V₁* and V₂*: reference voltages;

\tilde{V}₁ et \tilde{V}₂: voltage tracking errors;

R₂, R₃, and ε: adjustment parameters;

|i₁|: line current modules.

The term “sign” means a switching function, examples of which are given in FIGS. 12 and 13.

Advantageously, the algorithm for extracting the angle comprises a table, or a modeling process, or a binary search.

The invention also provides a method of controlling a TCSC disposed on a high voltage line of an electrical transmission network, which comprises the following steps:

a voltage measuring step that enables the harmonics of the voltage across the TCSC to be extracted;

a current measuring step that enables the amplitude of the fundamental and, optionally, those of any other harmonics in the current flowing in the high voltage line to be extracted;

a step of regulation in accordance with a non-linear control law, making use of the voltage and current measuring signals and a voltage reference signal corresponding to the fundamental of the voltage that is to be obtained across the TCSC, whereby to obtain an equivalent effective admittance;

a step of extracting the control angle in accordance with an angle extraction algorithm, using the said equivalent effective admittance whereby to obtain a control angle; characterized in that it further comprises:

a step of controlling the thyristors of the TCSC, using the said control angle together with a zero current reference that is delivered by a phase-locked loop giving the position of the current,

and in that the control law is such that

$$u = \{ \begin{matrix}{u}_{max} , & {u}_{tot} & \geq {u}_{max} & \\ {u}_{tot} , & {u}_{min} & \leq {u}_{tot} & \leq {u}_{max} \\ {u}_{min} , & {u}_{tot} & \leq {u}_{min} & \end{matrix}$$

where:

$${u}_{tot} = {u}^{*} - sign ( {u}^{*} ) {R}_{2} {\tilde{V}}_{2} + {u}^{*} {\tilde{V}}_{1} \frac{C}{{\tilde{V}}_{2} \vert {i}_{l} \vert} {\dot{V}}_{1}^{*} - {R}_{3} \frac{{\tilde{V}}_{1}}{\vert {\tilde{V}}_{1} \vert + ɛ}$$

and:

u*=ωₛC_{eff}(β*), the equivalent effective admittance at the equilibrium point (under steady conditions);

$${V}^{*} = {[ {V}_{1}^{*} , {V}_{2}^{*} ]}^{T} = {[ - \frac{\vert {i}_{l} \vert}{{u}^{*}} , 0 ]}^{T} \text{:}$$

reference voltage;

V₁ and V₂: measured voltages;

V₁* and V₂*: reference voltages;

\tilde{V}₁ et \tilde{V}₂: voltage tracking errors;

R₂, R₃, and ε: adjustment parameters;

|i₁|: line current modules.

The term “sign” means a switching function, examples of which are given in FIGS. 12 and 13.

The control law can with advantage be determined using an approach of the Lyapunov type.

Such a control law enables substantially improved robustness to be obtained, more particularly in capacitive mode. It also enables static errors to be eliminated in capacitive and inductive modes.

### BRIEF DESCRIPTION OF THE DRAWINGS

FIG. 1 shows active power as a function of the transmission angle, for three different values of the amount of compensation.

FIG. 2 is the block diagram of the TCSC.

FIG. 3 shows the impedance of the TCSC as a function of trigger angle.

FIG. 4 illustrates the operation of the TCSC in capacitive mode.

FIG. 5 illustrates the operation of the TCSC in inductive mode.

FIG. 6 shows the current and voltage curves for the TCSC in capacitive mode.

FIG. 7 shows the system of the invention.

FIG. 8 shows the equivalent effective admittance of the TCSC as a function of the angle β, in a system of the prior art.

FIG. 9 shows the static error on the voltage fundamental during operation close to resonance (58.7 degrees), in a system of the prior art.

FIG. 10 shows an approximation of the sign function.

FIG. 11 shows an “optimized” approximation of the sign function.

FIG. 12 shows the disappearance of the static error in the voltage fundamental, by means of the method of the invention.

FIGS. 13 to 15 show comparative results obtained with the control law defined in the document referenced [2], and with the control law of the invention.

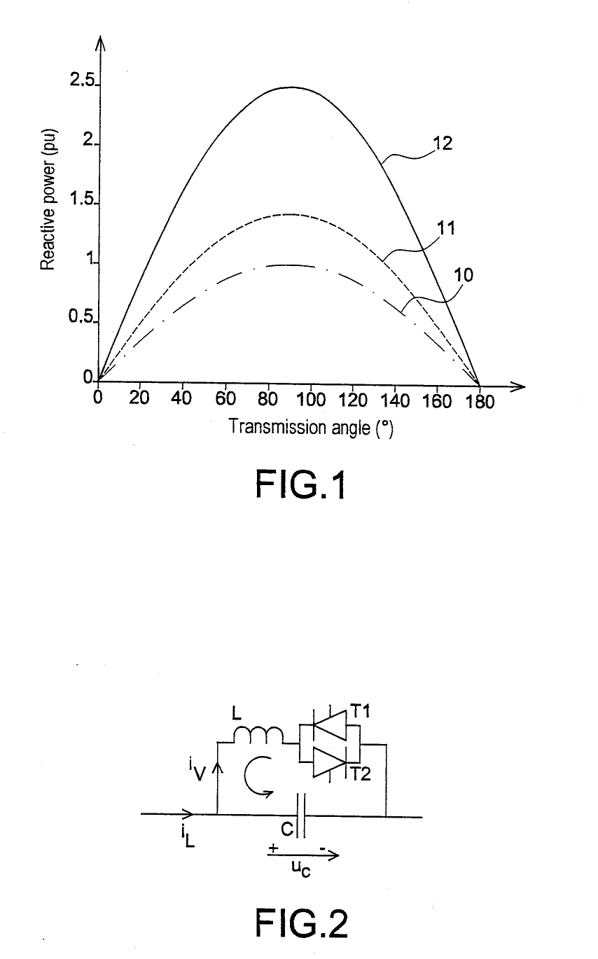

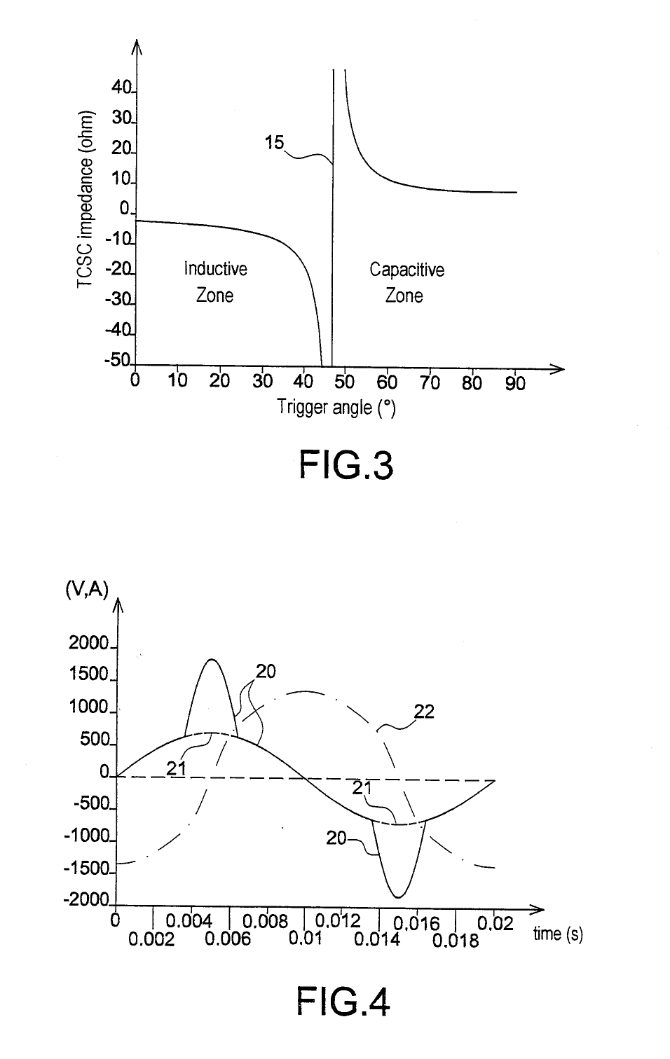

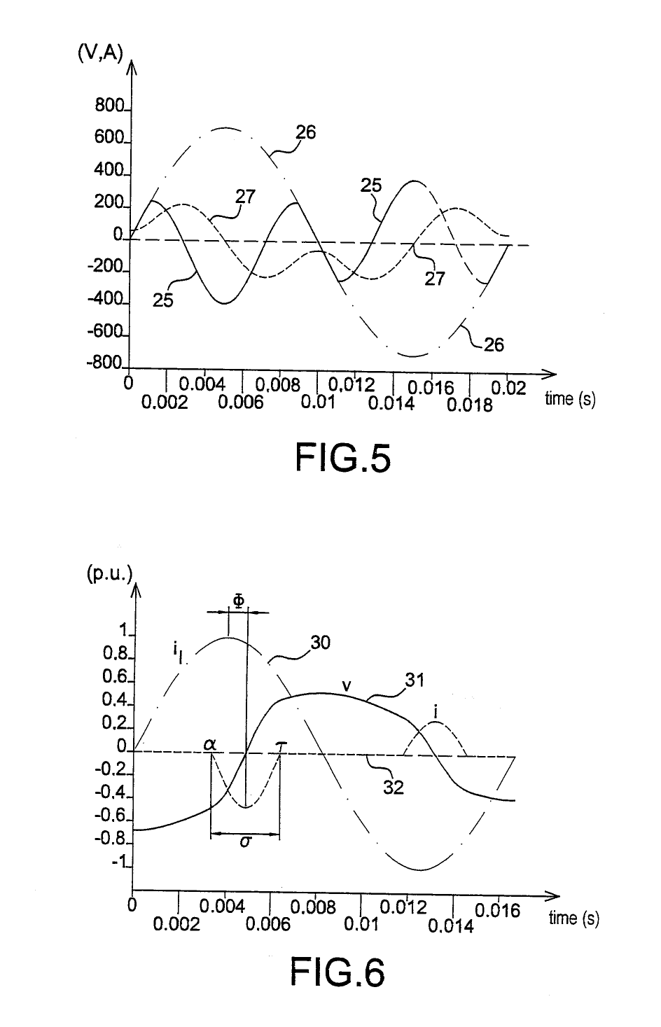

### DETAILED DESCRIPTION OF PARTICULAR EMBODIMENTS

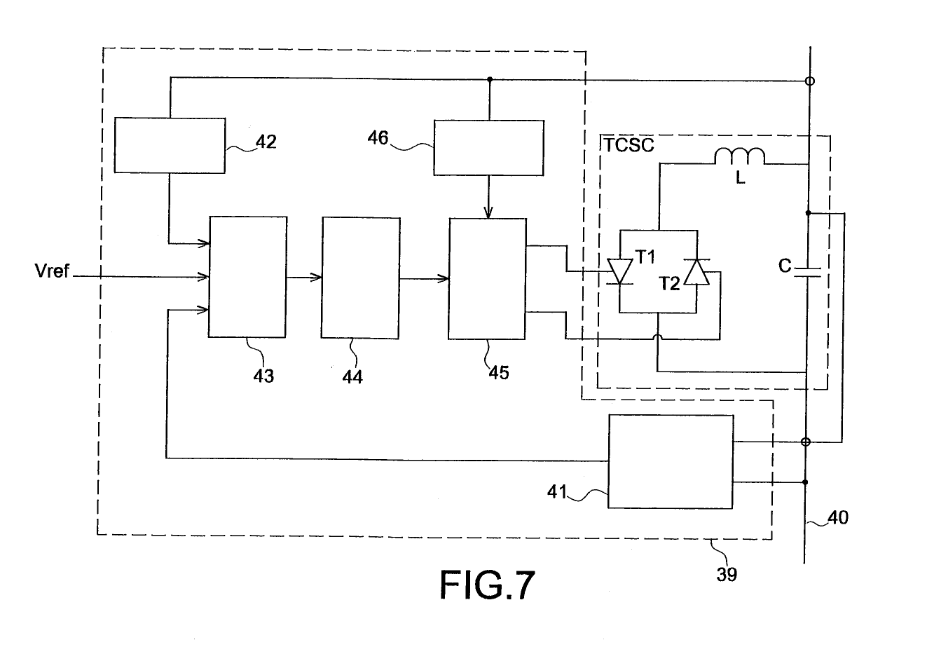

The control system for a TCSC in a power transmission network according to the invention is shown in FIG. 7. This TCSC, which is disposed on a high voltage line 40, comprises a capacitor C, an inductance L, and a set of two thyristors T1 and T2.

This control system 39 comprises the following:

a voltage measuring module 41 that enables the harmonics in the voltage across the TCSC to be extracted;

a current measuring module 42 that enables the amplitude of the fundamental, and optionally of other harmonics, of the current flowing in the high voltage line 40, to be extracted;

a regulator 43 that operates in accordance with a predetermined non-linear control law, and that receives on its input the output signals from the two modules 41 and 42 measuring voltage and current, and a reference voltage V_{ref} corresponding to the fundamental (harmonic 1 at 50 Hz) of the voltage that is to be obtained across the TCSC, the regulator delivering an equivalent effective admittance;

a module 44 for extracting the control angle in accordance with an angle extraction algorithm (for example a table, a modeling procedure, or a binary search), which receives the said equivalent effective admittance and delivers a control angle; and

a module 45 for controlling the thyristors T1 and T2 of the TCSC, which receives the said control angle and a zero current reference that is delivered by a phase-locked loop 46 giving the position of the current.

The method of controlling a TCSC disposed on the high voltage line of a power transmission network according to the invention accordingly comprises the following steps:

a voltage measuring step that enables the harmonics of the voltage across the TCSC to be extracted;

a current measuring step that enables the amplitude of the fundamental, and optionally of other harmonics, of the current flowing in the high voltage line to be extracted;

a step of regulation in accordance with a non-linear control law, making use of the voltage and current measuring signals and a voltage reference signal corresponding to the fundamental of the voltage that is to be obtained across the TCSC, whereby to obtain an equivalent effective admittance;

a step of extracting the control angle in accordance with an angle extraction algorithm, using the said equivalent effective admittance whereby to obtain a control angle; and

a step of controlling the thyristors of the TCSC using the said control angle together with a zero current reference that is delivered by a phase-locked loop giving the position of the current.

In order to describe the method of the invention more precisely, there follows an analysis in succession of a control law of the prior art, a first control law of the invention, and a second control law of the invention.

### Control Law of the Prior Art

A control law from the prior art, as described in the document referenced as [2], is now analyzed. This control law is obtained by an approach of the Lyapunov type.

The purpose of this control law is to maintain the fundamental of the voltage V across the TCSC at a reference value V*, and to damp out any disturbances by controlling the trigger angle of the thyristors. In this control law a simplified model of the fundamental of the voltage signal is considered.

Above, a detailed description is given of the process that enables a state model of the form:

$$\{ \begin{matrix}C \frac{d V}{d t} = {I}_{l} - I - JC {ω}_{s} V \\ L \frac{d I}{d t} = < qv > 1 - JL {ω}_{s} I\end{matrix}$$

to be obtained, where q is a switching function describing the state of the thyristors: thus, q=1 if one of the thyristors is closed, and q=0 when both thyristors are open. I and V are the fundamental Fourier coefficients (or 1-phasers) of i and v, which are respectively the current in the inductance and the voltage across the TCSC.

J designates the matrix:

$$( \begin{matrix}0 & - 1 \\ 1 & 0\end{matrix} ) ;$$

that is used as a replacement for the imaginary number j to express the phasers as vectors that comprise the real parts and the imaginary parts of the corresponding complex phasers.

It may also be recalled that the first phaser of the line current I1 is given by the formula I₁=[0,−|i₁|]^{T}, where |i₁| designates the amplitude of the current flowing in the line.

This state model may be reduced, while preserving high precision, by considering that the dynamics of the current phasers I are much larger than those of the voltage phasers V. This assumption can be confirmed by observing the actual values of the linearized system. It is thus possible to consider that, rapidly,

$$\frac{d I}{d t} \underline{\approx } 0.$$

From this, we have:

$$I = - J \frac{< qv > 1}{{ω}_{s} L}$$

Now, it is possible to write:

$$\frac{< qv > 1}{L} = \frac{V}{Leff ( σ )}$$

where L_{eff}(σ) is the effective inductance of the branch TCR, dependent on the conduction angle σ. We choose to replace this conduction angle σ with the semi-conduction angle

$$β = \frac{σ}{2} .$$

So finally, we get:

$$I = - J \frac{V}{{ω}_{s} {L}_{eff} ( σ )}$$

By replacing I with its new expression in the first equation of the system, we get:

$$C \frac{d V}{d t} = {I}_{1} + J \frac{V}{{ω}_{s} {L}_{eff}^{( β )}} - JC {ω}_{s} CV$$

$$C \frac{d V}{d t} = {I}_{1} - J {ω}_{s} ( C - \frac{1}{ {ω}_{s}^{2} {L}_{eff} ( β )} ) V$$

In general it is preferred to make use of the quasi-permanent effective capacitance C_{eff} rather than the effective inductance L_{eff}. These two magnitudes are linked by the following relationship:

$${L}_{eff} ( β ) = \frac{1}{{ω}_{s}^{2} ( C - {C}_{eff} ( β ) )}$$

This effective capacitance C_{eff} of the quasi-permanent state can be expressed as a function of the semi-conduction angle β, in the following equation:

$${C}_{eff} ( β ) = {\{ \frac{1}{C} - \frac{4}{π} [ \begin{matrix}\frac{1}{2 C} S ( β + \frac{sin ( 2 β )}{2} ) + \\ {ω}_{s}^{2} {LS}^{2} {cos}^{2} ( β ) ( tan ( β ) - ηtan ( ηβ ) )\end{matrix} ] \}}^{- 1}$$

Recalling the expression

$$η = \frac{{ω}_{0}}{{ω}_{s}} ,$$

we get the following relationship:

$$C \frac{d V}{d t} = {I}_{l} J {ω}_{s} {C}_{eff} ( β ) V$$

The control is represented here by β. This equation is then highly non-linear from the point of view of the control variable. Calculation of a control law from this equation would then be a laborious procedure.

As is proposed in the document referenced [2], it is however possible to re-write the above equation in a form which is more suitable for the design of a control law, as follows:

$$C \frac{d V}{d t} = {I}_{l} - Ju ( β ) V$$

The control input u has been defined here by postulating u(β)=ωₛC_{eff}(β).

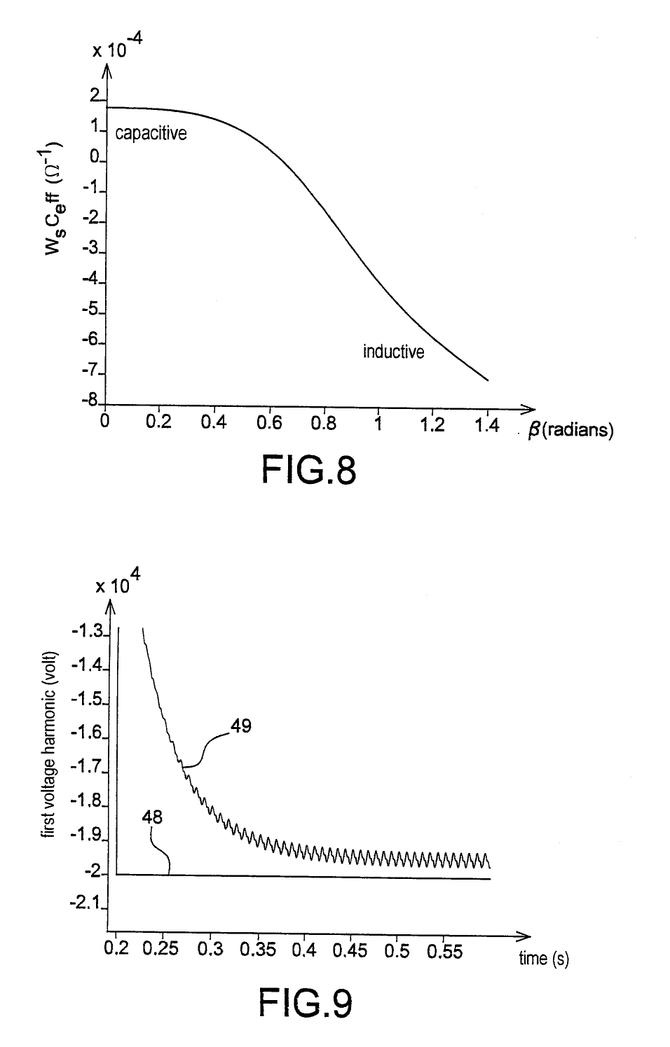

FIG. 8 shows the effective admittance u(β)=ωₛC_{eff}(β). The sign of this admittance varies depending on the mode of operation of the TCSC, being positive in capacitive mode and negative in inductive mode.

After the control signal u has been calculated, the angle β can be found by using the above equation giving Ceff(β) (for example by a binary search). It can also be taken from a previously established table. With β known, the trigger angle α (measured relative to the passage of the line current through zero) is deduced therefrom by calculating:

α=π/2−β

The control target consists in finding u (and therefore β) such that the effective admittance u(β)=ωₛC_{eff}(β) takes the constant reference value u*=ωₛC_{eff}(β*). The problem posed here is therefore a problem of regulating the state V of the system.

It should also be noted that the system described by the above equation giving CdV/dt requires a single equilibrium point

$$\overline{V} = \frac{- {JI}_{l}}{{u}^{*}}$$

for a given constant u*.

The target therefore consists in putting the voltage V at a constant reference value V*= V̅, by calculating the appropriate control signal u.

From the assumption I₁=[0,−|i₁|]^{T}, we get

$${V}^{*} = {[ {V}_{1}^{*} , {V}_{2}^{*} ]}^{T} = {[ - \frac{\vert {i}_{l} \vert}{{u}^{*}} , 0 ]}^{T}$$

Due to physical constraints, and for safety reasons, the control signal (i.e. effective admittance) is restricted to a given range for each operating regime:

uₘᵢₙ^{cap}<u<uₘₐₓ^{cap} (where cap=capacitive)
uₘᵢₙ^{ind}<u<ₘₐₓ^{ind} (where ind=inductive)

By modifying the model in such a way as to work on the dynamics of the errors, and no longer on the signal itself, these dynamics are given by the following set of equations:

C\tilde{V}₁=u\tilde{V}₂

C\tilde{V}₂=−u\tilde{V}₁−V₁*ũ

where (\tilde{•})=(•)−(•)*

Starting from this new model, the following Lyapunov function is considered:

$$W = \frac{C}{2} {\tilde{V}}^{T} \tilde{V} + \frac{\vert {i}_{1} \vert}{\vert {u}^{*} \vert b} {\int }_{0}^{z} sat ( τ ) d τ$$

where b is constant and positive, z is an auxiliary variable (being zero at equilibrium), and sat(τ) is a saturation function having the following properties:

τsat(τ)>0

sat(0)=0

satₘᵢₙ≦sat(τ)≦satₘₐₓ

It is common to make use of a Lyapunov function of this type in electrical technology. It may be regarded as being a form of mechanical energy, such as kinetic energy (first term), and potential energy (integral term).

It is easy to verify that W is indeed a Lyapunov function: this function is clearly zero at the equilibrium point (0,0)—we have z=0 at the equilibrium point—and is strictly positive everywhere else.

The time derivative of W along the paths of the system giving C\tilde{V}₁ and C\tilde{V}₂ are calculated as follows:

Let

$$h ( z ) = {\int }_{0}^{z} sat ( τ ) d r .$$

We then have

$$\frac{d h ( z )}{d t} = \frac{d h ( z )}{d z} \frac{d z}{d t} = sat ( z ) \dot{z} ,$$

which gives for the total derivative:

$$\dot{W} = - {\tilde{V}}_{2} {V}_{1}^{*} \tilde{u} + \frac{\vert {i}_{l} \vert sat ( z ) \dot{z}}{\vert {u}^{*} \vert b}$$

$$\dot{W} = \frac{\vert {i}_{l} \vert}{{u}^{*}} {\tilde{V}}_{2} \tilde{u} + \frac{\vert {i}_{l} \vert sat ( z ) \dot{z}}{\vert {u}^{*} \vert b}$$

$$\dot{W} = \frac{\vert {i}_{l} \vert}{\vert {u}^{*} \vert b} ( {V}_{2} \tilde{u} b + sign ( {u}^{*} ) sat ( z ) \dot{z} )$$

This derivative can be made negative with the following command:

ũ=−sign(u*)sat(z)

ż=−az+b\tilde{V}₂

where a is a positive constant.

The integers a and b may be seen as being adjustment coefficients. By using the two expressions given above, the derivative of the function W becomes:

$$\dot{W} = \frac{\vert {i}_{l} \vert}{{u}^{*} b} ( - sign ( {u}^{*} ) sat ( z ) {V}_{2} b + sign ( {u}^{*} ) sat ( z ) \dot{z} )$$

$$\dot{W} = - \frac{\vert {i}_{l} \vert a}{\vert {u}^{*} \vert b} z \cdot sat ( z )$$

The derivative is therefore negative. In addition:

$$\dot{W} = 0 \\ ⇔ z ≡ 0 \\ ⇔ \begin{matrix}\tilde{{V}_{2}} \\ \tilde{u}\end{matrix} \} = 0 \\ ⇔ {\tilde{V}}_{1} = 0$$

The single equilibrium point of this system is therefore the origin (0,0), and this point is asymptotically stable.

The system that gives ż converges towards sat(z), so that sat(z) is given by the following equation:

0=−asat(z)+b\tilde{V}₂

sat(z)=b/a\tilde{V}₂

Let b/a=R₂.

The control law is then given finally by the following expression:

$$u = \{ \begin{matrix}{u}_{max} , & {u}_{tot} & \geq {u}_{max} & \\ {u}_{tot} , & {u}_{min} & \leq {u}_{tot} & \leq {u}_{max} \\ {u}_{min} , & {u}_{tot} & \leq {u}_{min} & \end{matrix}$$

where:

uₜₒₜ=u*−sign(u*)R₂\tilde{V}₂

and hence:

ũ=uₜₒₜ−u*=sign(u*)R₂\tilde{V}₂

where R₂ is an adjustment parameter of the system.

With of a variable reference, the problem can be seen as a problem of trajectory tracking.

The error system then becomes:

C{tilde over (\dot{V}₁=u\tilde{V}₂−C\dot{V}₁*

C{tilde over (\dot{V}₂=−u\tilde{V}₁−V₁*ũ

This variation in reference introduces a new term into the command. This time, we have:

$$\tilde{u} = - sign ( {u}^{*} ) {R}_{2} {\tilde{V}}_{2} + {u}^{*} {\tilde{V}}_{1} \frac{C}{\vert {i}_{l} \vert {\tilde{V}}_{2}} {\dot{V}}_{1}^{*}$$

It is then naturally necessary to think about saturating the term \tilde{V}₂ in the denominator in order to prevent it from canceling itself out.

This additional term does not involve any difference in the final result, but it does enable a variable reference to be processed rigorously.

This model has proved effective on first use, and the dynamic is substantially identical to that of the open loop. However, as shown in FIG. 9, a static error is found to occur in the zones close to resonance, and the curve 48 illustrates the reference while the curve 49 shows the first harmonic.

This static error can be explained in several ways, namely inaccuracy of measurement, simplifications of the model and absence of any harmonic, poor gain control, and so on.

The object of the invention is therefore, in particular, to modify this law in such a way as to eliminate this static error.

### First Control Law of the Invention

In the method of the invention, the procedure described above to describe the control law of the prior art is largely retained. Accordingly, the simplified model remains the same, namely:

$$C \frac{d V}{d t} = {I}_{l} - Ju ( β ) V$$

The Lyapunov function set forth above is preserved, giving W, and this time the following term is added into the command:

−R₃sign(\tilde{V}₁)

It is also chosen, in order to avoid oscillation effects (“chattering”), to approximate to the sign function.

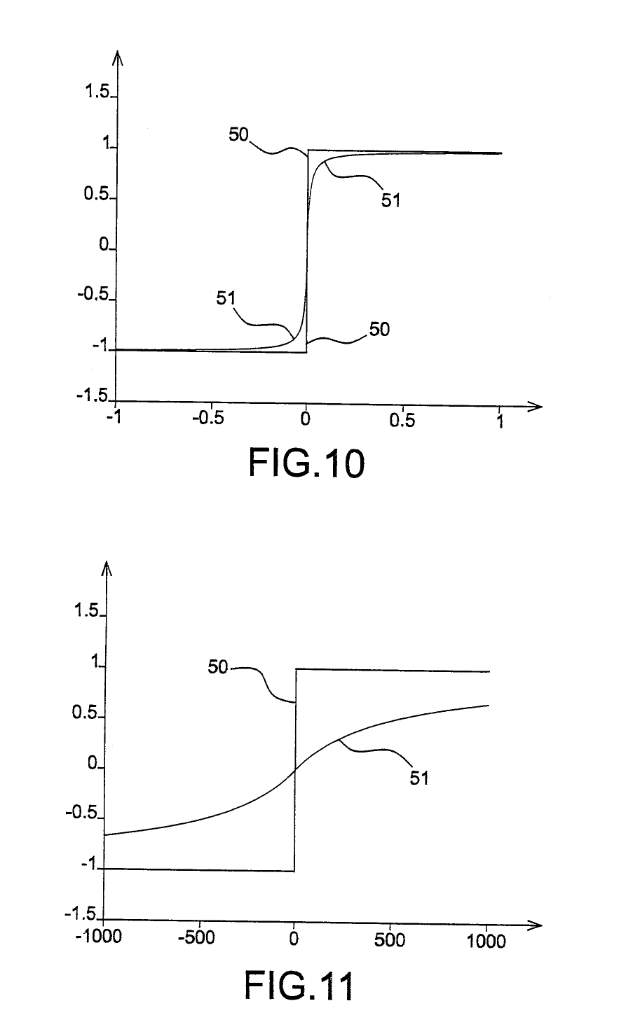

A first possibility consists in making use of an approximation of the following type:

$$sign ( x ) ≃ \frac{x}{\vert x \vert + ɛ}$$

where ε is quite small and is determined as a function of the time constant of the system as illustrated in FIG. 10, in which the curve 50 shows the sign function and curve 51 shows the approximate sign function.

However, a more effective approximation, which is shown in FIG. 11, is chosen to be used. The above formula remains identical, but s is chosen to be large so as to “flatten” the approximate sign function 51 in the region of the origin 0.

Such an approach reverts to the introduction of variable gain. Gain thus tends to zero when the error tends to zero (i.e. the controlled output signal tends towards the reference value), which avoids excessive operation of the actuator when the output signal is close to the reference value.

The control law then becomes:

$$\tilde{u} = - sign ( {u}^{*} ) {R}_{2} {\tilde{V}}_{2} + {u}^{*} {\tilde{V}}_{1} \frac{C}{{\tilde{V}}_{2} \vert {i}_{l} \vert} {\dot{V}}_{1}^{*} - {R}_{3} \frac{{\tilde{V}}_{1}}{\vert {\tilde{V}}_{1} \vert + ɛ}$$

where:

$${u}_{tot} = {u}^{*} - sign ( {u}^{*} ) {R}_{2} {\tilde{V}}_{2} + {u}^{*} {\tilde{V}}_{1} \frac{C}{{\tilde{V}}_{2} \vert {i}_{l} \vert} {\dot{V}}_{1}^{*} - {R}_{3} \frac{{\tilde{V}}_{1}}{\vert {\tilde{V}}_{1} \vert + ɛ}$$

It is possible to verify the stability of the system with this novel control law. The derivative of the function W becomes:

$$\dot{W} = \frac{\vert {i}_{1} \vert}{{u}^{*} b} \{ \begin{matrix}b {\tilde{V}}_{2} [ \begin{matrix}- sign ( {u}^{*} ) sat ( z ) - {R}_{3} sign ( {\tilde{V}}_{1} ) + \\ {u}^{*} {\tilde{V}}_{1} \frac{C}{{\tilde{V}}_{2} \vert {i}_{1} \vert} {\dot{V}}_{1}^{*}\end{matrix} ] + \\ sign ( {u}^{*} ) sat ( z ) \dot{z}\end{matrix} \} - C {\tilde{V}}_{1} {\dot{V}}_{1}^{*}$$

This time, the following relation is selected:

$$\dot{z} = - az + b {\tilde{V}}_{2} + {R}_{3} b {\tilde{V}}_{2} sign ( {u}^{*} ) sign ( {\tilde{V}}_{1} ) \frac{1}{sat ( z )}$$

which gives:

$$\dot{W} = \frac{\vert {i}_{1} \vert}{{u}^{*} b} ( \begin{matrix}- b {\tilde{V}}_{2} sign ( {u}^{*} ) sat ( z ) - {bV}_{2} {R}_{3} sign ( {\tilde{V}}_{1} ) + \\ sign ( {u}^{*} ) sat ( z ) \\ ( - az + b {\tilde{V}}_{2} + {R}_{3} b {\tilde{V}}_{2} sign ( {u}^{*} ) sign ( {\tilde{V}}_{1} ) \frac{1}{sat ( z )} )\end{matrix} )$$

$$\dot{W} = - \frac{\vert {i}_{1} \vert a}{\vert {u}^{*} \vert b} z \cdot sat ( z )$$

The system then remains stable with this novel control law.

In addition, we now have:

$$0 = - a \cdot sat ( z ) + b {\tilde{V}}_{2} + {R}_{3} {\tilde{V}}_{2} sign ( {u}^{*} ) sign ( {\tilde{V}}_{1} ) \frac{1}{sat ( z )}$$

in which:

$$sat ( z ) = \frac{b {\tilde{V}}_{2} \pm \sqrt{Δ}}{2 a}$$

where Δ=(b\tilde{V}₂)²+4aR₂\tilde{V}₂sign(V₁*)sign(\tilde{V}₁)

One solution consists in choosing Δ=0. In this way it is possible to find a relation linking a and b, which can be replaced in the expression for sat(z).

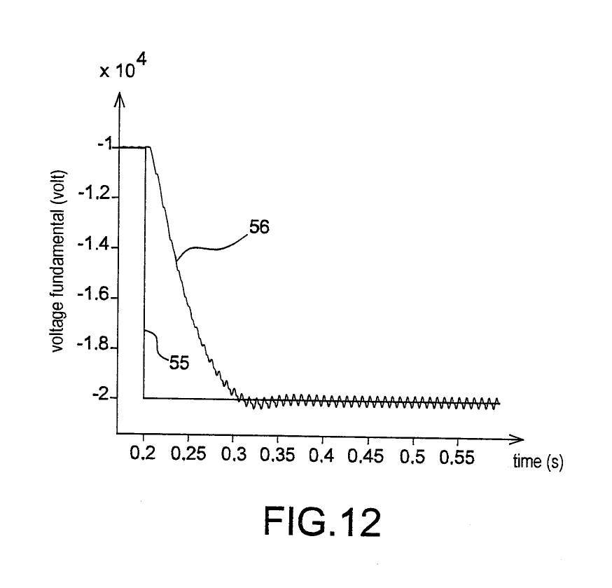

This control law enables the static error to be eliminated as is shown in FIG. 12 and even to improve the dynamics of the system, with curve 55 illustrating the reference line and curve 56 illustrating the first harmonic.

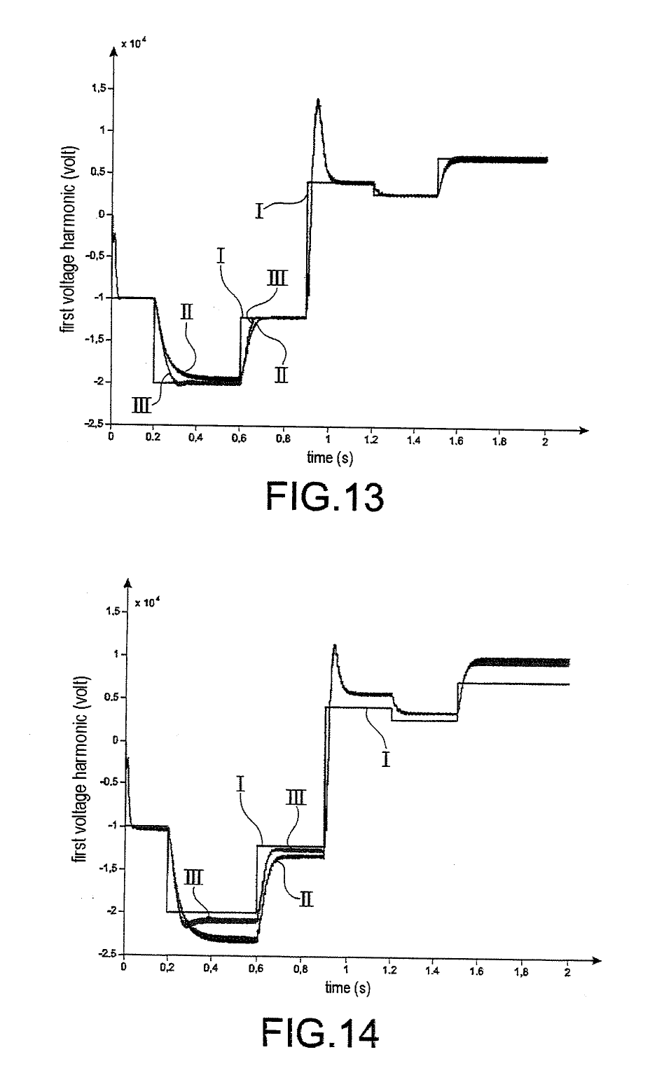

FIGS. 13 to 15 show comparative results obtained with the control law of the prior art, as defined in the document referenced [2], and with the first control law of the invention.

Accordingly, FIG. 13 shows operation without harmonics obtained successively in capacitive mode (from 0 to 0.9 seconds), and in inductive mode (from 0.9 to 2 seconds), with:

a reference signal I;

the signal II that is obtained as described in the document referenced [2]; and

the signal of the invention, III.

As is clearly shown between 0.2 seconds and 0.6 seconds, the control law of the invention enables the static error to be reduced as compared with the reference document [2]. In addition it permits a gain in rapidity.

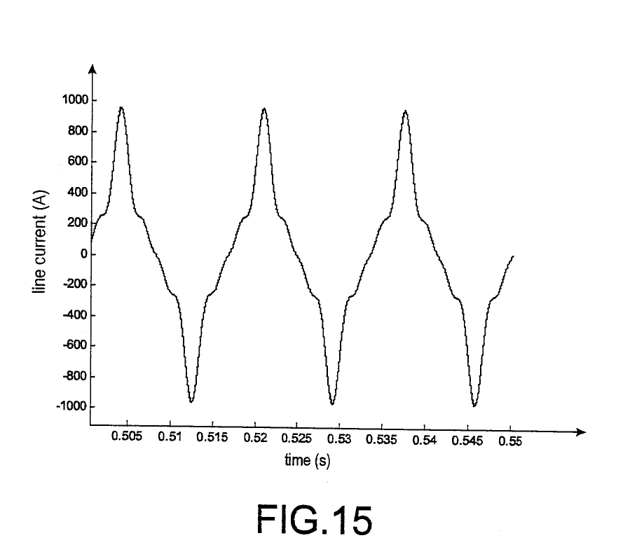

FIG. 14 shows an operation with a line current which includes harmonics, as illustrated in FIG. 15. The control law of the invention is less sensitive to disturbances (harmonics) than is document [2]. Besides which, it is more robust.

### Second Control Law of the Invention

The object of this second control law is to take account of harmonics in order to improve either the robustness or the dynamics of the control laws, by taking account of the contribution of harmonics as a measured disturbance.

Repetition of the above calculations gives the following simplified expression:

$$C \frac{d V}{d t} = {I}_{l} - Ju ( β ) V + J \frac{P}{L {ω}_{s}}$$

where P=[P₁, P₂]^{T} represents the contribution of the harmonics as known and measured.

The new equilibrium point of this system is given by the expression:

$${V}^{*} = \frac{1}{{u}^{*}} [ - \vert {i}_{l} \vert + \frac{{P}_{1}}{L {ω}_{s}} , \frac{{P}_{2}}{L {ω}_{s}} ]$$

This time, the error system obtained is the following:

$$C {\dot{\tilde{V}}}_{1} = u {\tilde{V}}_{2} + ( u - 1 ) \frac{{P}_{2}}{L {ω}_{s}}$$

$$C {\dot{\tilde{V}}}_{2} = - u {\tilde{V}}_{1} - {V}_{1}^{*} \tilde{u}$$

Since the Lyapunov function is still given by the expression:

$$W = \frac{C}{2} {\tilde{V}}^{T} \tilde{V} + \frac{\vert {i}_{1} \vert}{\vert {u}^{*} \vert b} {\int }_{0}^{z} sat ( τ ) d τ$$

its derivative now becomes:

$$\dot{W} = \frac{\vert {i}_{1} \vert}{{u}^{*}} \{ \begin{matrix}\tilde{u} {\tilde{V}}_{2} ( 1 - \frac{{P}_{1}}{L {ω}_{s}} \frac{1}{\vert {i}_{1} \vert} + \frac{{u}^{*} {\tilde{V}}_{1}}{\vert {i}_{1} \vert {\tilde{V}}_{2}} \frac{{P}_{2}}{L {ω}_{s}} ) + \\ sign ( {u}^{*} ) \frac{sat ( z )}{b} \dot{z}\end{matrix} \} + ( {u}^{*} - 1 ) {\tilde{V}}_{1} \frac{{P}_{2}}{L {ω}_{s}}$$

This derivative may be made negative by invoking the second control law as follows:

$$\tilde{u} = ( \begin{matrix}- sign ( {u}^{*} ) {R}_{2} {\tilde{V}}_{2} - \\ ( {u}^{*} - 1 ) \frac{{u}^{*} {\tilde{V}}_{1}}{\vert {i}_{1} \vert {\tilde{V}}_{2}} \frac{{P}_{2}}{L {ω}_{s}}\end{matrix} ) \frac{1}{1 - \frac{{P}_{1}}{L {ω}_{s}} \frac{1}{\vert {i}_{1} \vert} + \frac{{u}^{*} {\tilde{V}}_{1}}{\vert {i}_{1} \vert {\tilde{V}}_{2}} \frac{{P}_{2}}{L {ω}_{s}}}$$

The contribution of the harmonics, the spectrum of which can cause high frequencies to appear, is filtered in order to avoid destabilization of the system, by saturating the command.

In this example, the result illustrated above in FIG. 12 is obtained, with the static error then also being cancelled out.

1. A control system for a TCSC disposed on a high voltage line of an electrical transmission network, which comprises:
a voltage measuring module which enables the harmonics of the voltage across the TCSC to be extracted;
a current measuring module which enables the amplitude of the fundamental, and any other harmonics, of the current flowing in the high voltage line to be extracted;
a regulator working in accordance with a non-linear control law, which receives as input the output signals from the two modules measuring voltage and current, and a reference voltage corresponding to the fundamental of the voltage which is required to be obtained across the TCSC, the regulator delivering an equivalent effective admittance;
a module for extracting the control angle in accordance with an extraction algorithm which receives the said equivalent effective admittance and which delivers a control angle;
a module for control of the thyristors of the TCSC, which receives the said control angle and a zero current reference which is delivered by a phase-locked loop giving the position of the current,
wherein the control law is such that:
$$u = \{ \begin{matrix}{u}_{max} , & {u}_{tot} \geq {u}_{max} \\ {u}_{tot} , & {u}_{min} \leq {u}_{tot} \leq {u}_{max} \\ {u}_{min} , & {u}_{tot} \leq {u}_{min}\end{matrix}$$
where:
$${u}_{tot} = {u}^{*} - sign ( {u}^{*} ) {R}_{2} {\tilde{V}}_{2} + {u}^{*} {\tilde{V}}_{1} \frac{C}{{\tilde{V}}_{2} \vert {i}_{l} \vert} {\dot{V}}_{1}^{*} - {R}_{3} \frac{{\tilde{V}}_{1}}{\vert {\tilde{V}}_{1} \vert + ɛ}$$
and:
u*=ωₛC_{eff}(β*), the equivalent effective admittance at the equilibrium point (under steady conditions);
$${V}^{*} = {[ {V}_{1}^{*} , {V}_{2}^{*} ]}^{T} = {[ - \frac{\vert {i}_{l} \vert}{{u}^{*}} , 0 ]}^{T} \text{:}$$
reference voltage;
V₁ and V₂: measured voltages;
V₁* and V₂*: reference voltages;
\tilde{V}₁ and \tilde{V}₂: voltage tracking errors;
R₂, R₃ and ε: adjustment parameters;

|i₁|: line current modules;
sign: commutation function.

2. A system according to claim 1, wherein the algorithm for extraction of the angle comprises a table, or a modeling process, or a binary search.

3. A method of control of a TCSC disposed on a high voltage line of an electrical transmission network, which comprises the following steps:
a voltage measuring step which enables the harmonics of the voltage across the TCSC to be extracted;
a current measuring step which enables the amplitude of the fundamental and, optionally, those of any other harmonics in the current flowing in the high voltage line to be extracted;
a step of regulation in accordance with a non-linear control law, making use of the voltage and current measuring signals and a voltage reference signal corresponding to the fundamental of the voltage that is required to be obtained across the TCSC, whereby to obtain an equivalent effective admittance;
a step of extracting the control angle in accordance with an angle extraction algorithm, using the said equivalent effective admittance whereby to obtain a control angle;
a step of controlling the thyristors of the TCSC, using the said control angle together with a zero current reference which is delivered by a phase-locked loop giving the position of the current,
wherein the control law is such that
$$u = \{ \begin{matrix}{u}_{max} , & {u}_{tot} \geq {u}_{max} \\ {u}_{tot} , & {u}_{min} \leq {u}_{tot} \leq {u}_{max} \\ {u}_{min} , & {u}_{tot} \leq {u}_{min}\end{matrix}$$
where
$${u}_{tot} = {u}^{*} - sign ( {u}^{*} ) {R}_{2} {\tilde{V}}_{2} + {u}^{*} {\tilde{V}}_{1} \frac{C}{{\tilde{V}}_{2} \vert {i}_{l} \vert} {\dot{V}}_{1}^{*} - {R}_{3} \frac{{\tilde{V}}_{1}}{\vert {\tilde{V}}_{1} \vert + ɛ}$$
and:
u*=ωₛC_{eff}(β*), the equivalent effective admittance at the equilibrium point (under steady conditions);
$${V}^{*} = {[ {V}_{1}^{*} , {V}_{2}^{*} ]}^{T} = {[ - \frac{\vert {i}_{l} \vert}{{u}^{*}} , 0 ]}^{T} \text{:}$$
reference voltage;
V₁ and V₂: measured voltages;
V₁* and V₂*: reference voltages;
\tilde{V}₁ and \tilde{V}₂: voltage tracking errors;
R₂, R₃ and ε: adjustment parameters;

|i₁|: line current modules;
sign: commutation function.

4. A method according to claim 3, wherein the angle extraction algorithm is obtained by using a table, a modeling process, or a binary search.

5. A method according to claim 3, wherein the control law is determined from an approach of the Lyapunov type.
